(19) United States
(12) Patent Application Publication
(10) Pub. No.: US 2011/0295823 A1
(43) Pub. Date: Dec. 1, 2011

(54) METHOD AND APPARATUS FOR MODELING RELATIONS AMONG DATA ITEMS

(75) Inventor: Sailesh Kumar Sathish, Tampere (FI)

(73) Assignee: Nokia Corporation, Espoo (FI)

(21) Appl. No.: 12/787,234

(22) Filed: May 25, 2010

(51) Int. Cl. G06F 17/30

(52) U.S. Cl. 707/705; 707/802; 707/E17.005

(57) ABSTRACT

An approach is provided for modeling relations among data items of an information resource. A modeling manager retrieves, at a device, a first data item and determines one or more data types associated with the first data item. Based, at least in part, on the one or more data types, the modeling manager determines one or more relations corresponding to the first data item based, at least in part, on the one or more data types. The modeling manager then associates the first data item with a second data item based, at least in part, on a semantic relationship among the first data item, the second data item, the one or more relations, or a combination thereof.

### BACKGROUND

Service providers (e.g., wireless, cellular, etc.) and device manufacturers are continually challenged to deliver value and convenience to consumers by, for example, providing compelling network services. Increasingly, these network services provide easy access to a vast library of online and offline information resources (e.g., online databases, local databases, service databases, application databases, etc.). However, because of the vast extent of many of these information resources (e.g., a map database containing millions of data items or records for points of interest), information owners and users (e.g., service providers and device manufacturers) face significant technical challenges to updating, extending, and otherwise maintaining the data within the information resources.

### Some Example Embodiments

Therefore, there is a need for an approach for efficiently modeling, generating, and/or updating the data within information resources and the relationships or connections among the data.

According to one embodiment, a method comprises retrieving, at a device, a first data item. The method also comprises determining one or more data types associated with the first data item. The method further comprises determining one or more relations corresponding to the first data item based, at least in part, on the one or more data types. The method further comprises associating the first data item with a second data item based, at least in part, on a semantic relationship among the first data item, the second data item, the one or more relations, or a combination thereof.

According to another embodiment, an apparatus comprising at least one processor, and at least one memory including computer program code for one or more programs, the at least one memory and the computer program code configured to, with the at least one processor, cause, at least in part, the apparatus to retrieve, at a device, a first data item. The apparatus is also caused to extract language tokens from the information resources. The apparatus is further caused to determine one or more data types associated with the first data item. The apparatus is further caused to determine one or more relations corresponding to the first data item based, at least in part, on the one or more data types. The apparatus is further caused to associate the first data item with a second data item based, at least in part, on a semantic relationship among the first data item, the second data item, the one or more relations, or a combination thereof.

According to another embodiment, a computer-readable storage medium carrying one or more sequences of one or more instructions which, when executed by one or more processors, cause, at least in part, an apparatus to retrieve, at a device, a first data item. The apparatus is also caused to extract language tokens from the information resources. The apparatus is further caused to determine one or more data types associated with the first data item. The apparatus is further caused to determine one or more relations corresponding to the first data item based, at least in part, on the one or more data types. The apparatus is further caused to associate the first data item with a second data item based, at least in part, on a semantic relationship among the first data item, the second data item, the one or more relations, or a combination thereof.

According to another embodiment, an apparatus comprises means for retrieving, at a device, a first data item. The apparatus also comprises means for determining one or more data types associated with the first data item. The apparatus further comprises means for determining one or more relations corresponding to the first data item based, at least in part, on the one or more data types. The apparatus further comprises means for associating the first data item with a second data item based, at least in part, on a semantic relationship among the first data item, the second data item, the one or more relations, or a combination thereof.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of modeling relations among data items of one or more information resources, according to one embodiment;

FIG. 2 is a diagram of the components of a modeling manager, according to one embodiment;

FIG. 3 is a diagram of additional components of a modeling manager for generating relations using a language model, according to one embodiment;

FIG. 4 illustrates a graphical representation of a language modeling lattice comprising a plurality of language tokens, according to one embodiment;

FIG. 5 is a flowchart of a process for modeling relations among data items of one or more information resources, according to one embodiment;

FIG. 6 is a flowchart of a process for monitoring an information resource to automatically generate relations among data items, according to one embodiment;

FIG. 7 is a flowchart of a process for iteratively processing an information resource to generate relations among data items, according to one embodiment;

FIG. 8 is a diagram of user interfaces used in the processes of FIGS. 5-7, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for modeling relations among data items of information resources are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

Various embodiments are described with respect to information resources or data structures (e.g., online databases, local databases, service databases, application databases, etc.) that are represented according to a Resource Description Framework (RDF). As used herein, RDF refers to a family of World Wide Web consortium (W3C) specifications originally designed as a metadata model. It has come to be used as a general method for conceptual description or modeling of information that is implemented in web resources; using a variety of syntax formats. By way of example, RDF data structures typically represent data items in a triple format including a subject, predicate, and object, wherein the predicate describes a relation or connection between the subject (e.g., one or more data fields of the data item representing the subject) and object (e.g., one or more data fields of the data item representing the object). As used herein, the term “relation” and “predicate” are used interchangeably and synonymously. In addition, it is contemplated that the approach described herein is applicable to information resources represented according to any other data standards including, but not limited to, RDF Schema (RDFS), OWL (Web Ontology Language), rule sets in RuleML (Rule Markup Language), key-value pairs, etc.

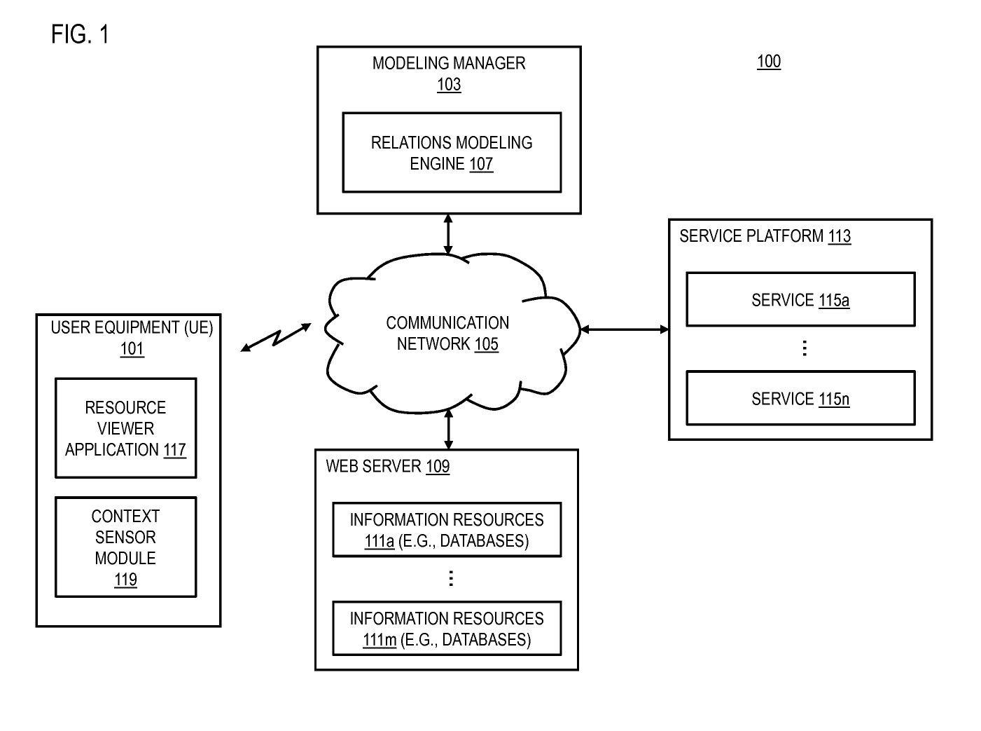

FIG. 1 is a diagram of a system capable of modeling relations among data items of one or more information resources, according to one embodiment. As described previously, one key challenge facing service providers and device manufacturers is how to update, extend, maintain, etc. data in information resources or databases that can potentially contain vast numbers of data items or records. By way of example, mapping and navigation related services typically maintain databases containing millions of points of interest (POIs). These POIs, in turn, are often associated with any number of descriptive features that can be represented as triples to describe relations of the POIs. For example, one feature may describe the name of POI (e.g., a triple <“POI”, “Name”, “City Café”>; where “POI” is the subject, “Name” is the predicate or relation between the subject and the object, and “City Café” is the object), location (e.g., <“City Café”, “Location”, “123 Main St.”), a characteristic (e.g., <“City Café”, “Food Type”, “Italian”>), and the like.

Historically, much of the information in many databases and information resources (e.g., mapping database) is collected and stored by field agents who research or otherwise retrieve the information. Because of the burden associated with manually collecting and associating the information, many databases often have data items that include lists of data without many relations or connections among the data or lists. In other words, databases and information resources may contain many subjects but often lack predicates and objects because there is huge effort associated with defining the predicates and then relating the subjects and objects through those defined predicates.

To address this problem, a system 100 of FIG. 1 introduces the capability to generate predicates or relations between data items of one or more information resources based, at least in part, on a semantic relationship among the data items and/or the relations. In one embodiment, the semantic relationships are discovered using statistical matching with respect to the one or more language models. By way of example, the language models generate or extract language tokens from the data items and/or relations and then determine a probability of the respective language tokens of the data items and/or relations matching.

In one embodiment, the system 100 can operate automatically to generate the relations by, for instance, applying the predicate generation process iteratively on the data items of the one or more information resources.

In another embodiment, the system 100 enables a user to specify predicates or relations that can then link data items based on semantic relationships. In some embodiments, the user-specified predicates may be used as language tokens in the language model to generate corresponding relations. The system 100 may then present the newly generated relations or previously generated and stored relations that are similar to the user-specified relation for user approval.

In yet another embodiment, the system 100 may automatically determine whether the data items in a particular information resource includes a predetermined (e.g., a minimum number) number of relations or predicates. If a particular data item does not include or is not associated with the predetermined number of relations, the system 100 can generate additional relations or fill in missing relations.

In certain embodiments, the system 100 may monitor the one or more information resources and then trigger the predicate generation process if changes to the information resources are detected. In addition or alternatively, the system 100 may initiate the predicate generation process on a periodical basis, according to a schedule, or the like. In this way, the system 100 may continuously update the relations among the data items when there are changes to the information resources that can affect the relations.

By providing the capability to generate predicates, the system 100 advantageously enables service providers, information owners, users, and the like to easily link missing relations from one information resource (e.g., a database) to another with minimal manual input, thereby reducing the burden for creating such information resources. In addition, the system 100 enables generation of completely new relations to extend and enrich the respective databases.

In one sample use case that is described in the context of a mapping service, a user can add a new relation to all or a class of POIs. For example, the user is viewing POIs that are restaurants and would like to know the average wait time for a table. The current mapping database does not have this relationship. Using the approach described herein, the user can add a new relation (e.g., “Wait Time”) to the POI database. On receiving the request to add the relation, the system 100 can evaluate existing information resources based on their semantic relationship to one or more data types associated with the POIs (e.g., restaurant data type, cuisine data type, hours of operations data type, etc.). This evaluation may include automatically traversing or accessing the data from other available resources (e.g., review guide databases, web sites, blogs, etc.) to determine whether any of the searched resources include information related to or about wait times at restaurants. The information regarding wait times can then be automatically associated with the respective POIs. As a result, when the user accesses the POI again, the relation of the POI with regard to wait times can be displayed.

As shown in FIG. 1, user equipment (UE) 101 has connectivity to a modeling manager 103 via the communication network 105. For the sake of simplicity, FIG. 1 depicts only a single UE 101 in the system 100. However, it is contemplated that the system may support any number of UEs 101 up to the maximum capacity of the communication network 105. For example, the network capacity may be determined based on available bandwidth, available connection points, and/or the like. As described previously with respect to the system 100, the modeling manager 103 retrieves data items from one or more information resources available over the network 105 and generates relations and/or suggestions for relations to link or connect the data items and/or the information resources corresponding to the data items.

In one embodiment, one or more of the information resources may be provided by the web server 109 which includes or has access to one or more information resources 111a-111n (e.g., databases, web pages, documents, files, media, etc.). In addition or alternatively, the information resources may be provided by the service platform 113 which includes services 115a-115m (e.g., music service, mapping service, video service, social networking service, content broadcasting service, etc.). In some embodiments, the information resources of the service platform 113 are provided via the web server 109. By way of example, the information resources and/or the corresponding data items includes one or more identifiers, metadata, access addresses (e.g., network addresses such as a URI, URL, URN, or Internet Protocol address; or a local address such as a file or storage location in a memory of the UE 101), previously defined relations, descriptions, categories, preference information, or the like associated with the information resources.

In certain embodiments, the modeling manager 103 interacts with a resource viewer application 117 executing on the UE 101 to facilitate interaction or other control between the UE 101 and the modeling manager 103. The resource viewer application 117 displays, for instance, data items from the information resources 111 and any available relations (e.g., predetermined relations, previously defined relations, etc.) associated with the data items. In one embodiment, the resource viewer application 117 also enables the user to provide input for specifying new relations and/or information for defining new relations and transmit the information to the modeling manager 103. In one embodiment, the resource viewer application 117 may operate on a common web browsing platform (e.g., Web Run Time (WRT)) as a client application of the modeling manager 103. In addition or alternatively, the resource viewer application 117 can be implemented in another programming language or development tool including Java, Qt, and the like.

The UE 101 also includes a context sensor module 119 for detecting or sensing one or more contextual characteristics (e.g., time, location, current activity, etc.) associated with device. This contextual information can then be transmitted to the modeling manager 103 as input for generating new relations. For example, transmitting temperature sensor information may cause the modeling manager 103 to generate a relation with a particular item related to the temperature information (e.g., relating a current temperature to a particular POI). By way of example, the context sensor module 119 may include one or more of a global positioning system (GPS) receiver for determining location, an accelerometer to determine movement or tilt angle, a magnetometer to determine directional heading, a microphone to determine ambient noise, a light sensor, a camera, and/or the like. In addition or alternatively, the modeling manager 103 may obtain contextual information from one or more of the services 115a-115m (e.g., a weather service, a location tracking service, social network service, etc.) for generating relations or predicates among data items.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, Personal Digital Assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

Additionally, in certain embodiments, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), or any other suitable packet-switched network, such as a commercially owned, proprietary packet-switched network, e.g., a proprietary cable or fiber-optic network. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), satellite, mobile ad-hoc network (MANET), and the like.

By way of example, the UE 101, modeling manager 103, web server 109, and service platform 113 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the resource viewer application 117 and the modeling manager 103 may interact according to a client-server model. According to the client-server model, a client process sends a message including a request to a server process, and the server process responds by providing a service (e.g., providing map information). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

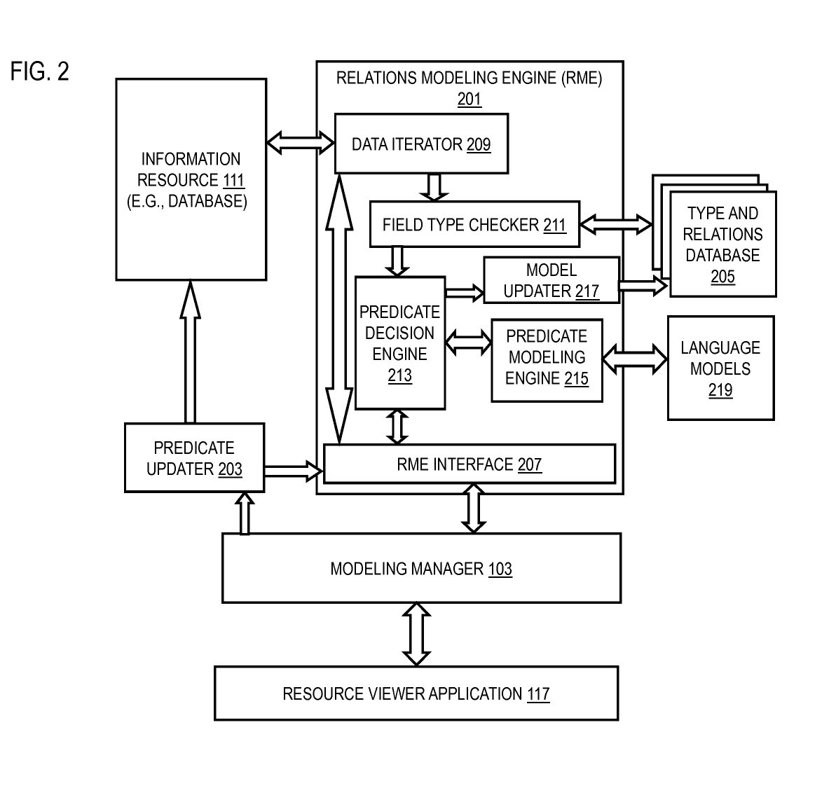

FIG. 2 is a diagram of the components of a resource manager, according to one embodiment. By way of example, the modeling manager 103 includes one or more components for generating relations or predicates among data items from one or more information resources. It is contemplated that the functions of these components may be combined in one or more components or performed by other components of equivalent functionality. As shown, a resource viewer application 117 (e.g., executing on a UE 101) provides a user interface for interacting with the modeling manager 103. As previously described, the resource viewer application 117 may be implemented as a web-based service, a dedicated application, an application programming interface (API) service, or the like with respect to the modeling manager 103.

In this embodiment, the modeling manager 103 includes or has access to at least a relations modeling engine (RME) 201 for generating or otherwise obtaining relations or predicates between data items. After obtaining the predicates, the modeling manager 103 interacts with the predicate updater 203 to make updates to the information resource 111. In one embodiment, the updates contain the predicates and the data items (e.g., subject and object) that the predicate tries to connect or relate.

In some embodiments, the modeling manager 103 can monitor content in the information resource 111 that can trigger generation of new predicates. As noted previously, the word “predicates” and “relations” are used interchangeably and carry the same meaning More specifically, predicates/relations describe a relationship or connection between a subject (e.g., a first data item) and an object (e.g., a second data item). For example, in a mapping service, a relation such as “restaurant” can be added to an area call “Central Station” (e.g., a first data item or subject). The final outcome of the association would be a subject-predicate-object triple such as <“Central Station”, “restaurant”, “Rose Garden Restaurant”>.

In one embodiment, the RME 201 performs one or more of a variety of functions. First, the RME 201 checks the data types of the subject data item (e.g., a first data item). Then, based on determined data types, the RME 201 determines what relations or predicates can be formed according to the data type. The RME 201 can also determine whether a data item is associated with a predetermined or adequate number of relations and generates new relations if needed. Next, the RME 201 generates features (e.g., a second data item, an object, a description, a set of labels, etc.) that describe the relation. In one embodiment, the relations (e.g., as full triples) and features including the data type to which the relation and corresponding data items belong are stored in the type and relations database 205. In yet another embodiment, the functions of the RME 201 are triggered by the modeling manager 103.

As shown in FIG. 2, the RME 201 includes several modules. More specifically, the RME 201 includes an RME interface 207 that provides an external interface to any external modules. In this example, the modeling manager 103 is external to the RME and uses the RME interface 207 to interact with the internal modules of the RME 201. In other embodiments, the RME 201 may be embedded within the modeling manager 103.

The RME 201 also includes a data iterator 209. The data iterator 209 iterates through each data structure or data item of the information resource 111 and feeds the fields associated with the data item to the field type checker (FTC) 211. In one embodiment, the operation of the data iterator 209 is triggered by the modeling manager 103.

On receiving the feed from the data iterator 209, the FTC 211 determines the data type of data items or data structure and checks whether any relations have been defined within the type and relations database (TRD) 205 for that particular data type. The type information is usually contained in the information resource 111 or its associated metadata. In some embodiments, the type information is defined by a separate ontology associated with the information resource 111. Relations can then be defined depending on the data types. For example, in a mapping service, a particular type of POI (e.g., a fountain) can have some pre-defined relations (e.g., data of installation, historical significance, owner, location, etc.). A data item of another type (e.g., a car) may have other relations (e.g., make, model, year, etc.). The FTC 211 checks what relations are available for a given data type and feeds the relation list along with the data item or data structure to the predicate decision engine (PDE) 213.

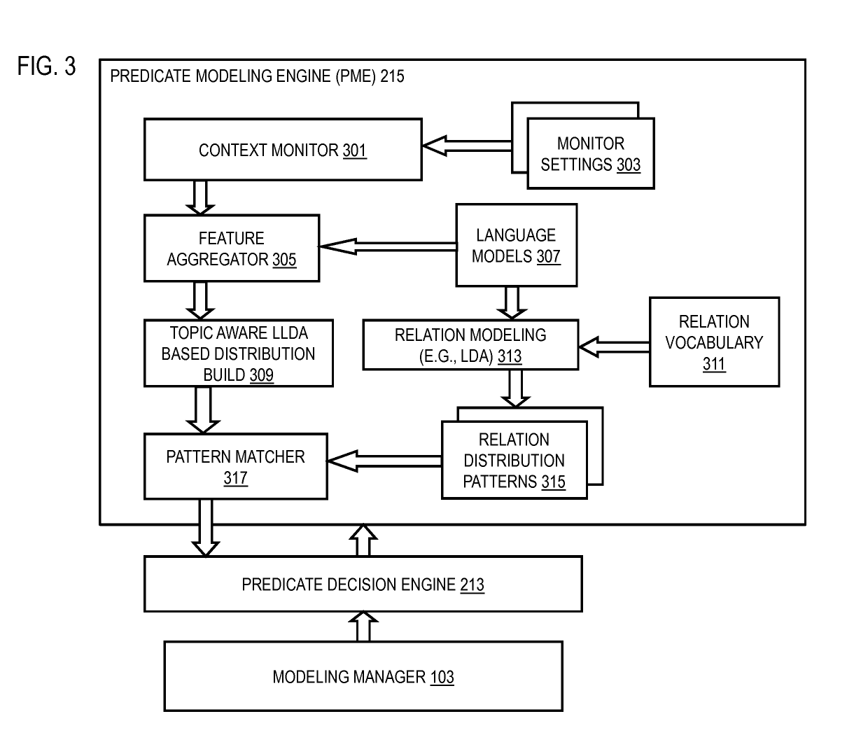

The PDE 213 looks at the relation list for a particular data item or structure (e.g., a POI) and determines from the list what relations are already there for the data item. If some relations are missing (e.g., as determined from the TRB 205 based on the specific data type), the PDE 213 can generate and add the missing relations. The PDE 213 can then forward those relations which were either missing or those whose fields currently stand empty to the modeling manager 103. The PDE 213 can also be instructed to generate features for a new relation type or predicate defined by as user. The PDE 213 relies on the predicate modeling engine (PME) 215 to perform this task. The PME 215, in turn, uses the model update 217 to update newly generated relations and their features to the TRD 205. The functions of the PME 215 are described in greater detail in the discussion below with respect to FIG. 3.

FIG. 3 is a diagram of additional components of a modeling manager for generating relations using a language model, according to one embodiment. In one embodiment, the modeling manager 103 has connectivity to the PME 215 of the RME 201 for generating automatic relations and corresponding features. By way of example, the PME 215 includes one or more components for executing the functions of the PME 215. It is contemplated that the functions of these components may be combined in one or more components or performed by other components of equivalent functionality.

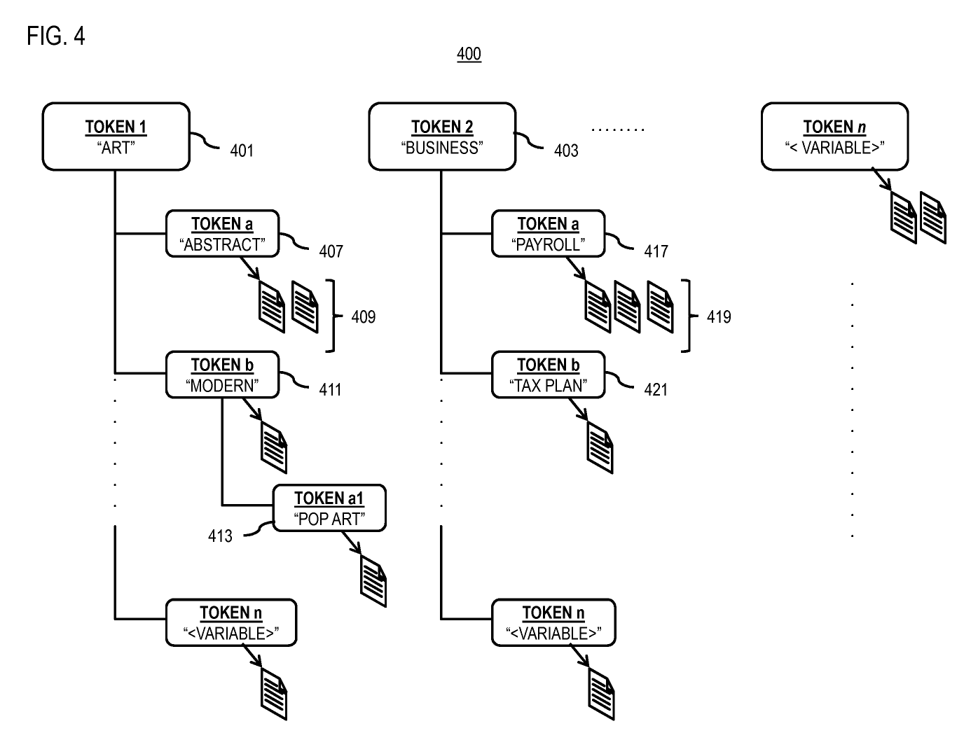

In one embodiment, the PME 215 can operate based on a user provided relation or predicate or based on an automatically generated predicate. When operating based on a user provided predicate, the PME receives an input from the user for specifying a relation name. In one embodiment, the input is received at the PME 215 from the modeling manager 103 via the PDE 213. In one embodiment, the PME 215 refers to one or more language models that contain a matrix of word tokens where the presence of each word the lattice of the model signifies a relation between that word and neighboring words in the lattice (see, e.g., the discussion below with respect FIG. 4 for a more detailed description of the language model). The PDE 213 extracts a set of words that fall within a certain perimeter of the lattice of the language model with one or more of the set of words at the apex of the lattice structure. In one embodiment, the size and shape of the perimeter is determined by the data type that is being addressed or any feature list that is supplied by the user along with the relation description.

For example, if the user supplied a new relation if the user supplied a new relation called “Eatery” and then provided additional tags (e.g., features) such as food, then the PME 215 can decide to take a default size spanning three words of the lattice, an elliptical shape for an area enclosed by the perimeter, and a direction of enclosure oriented towards food-related tokens within the lattice. So all words that fall within an elliptical enclosure with long axis of three words and short axis of two words (for example) will be taken as tokens that describe the relation “Eatery”. If no features are given, a circle of radius three words (example number) is taken as a default. The words extracted may be further filtered through a POST (part of speech tagging) process extracting only the noun words followed by a filter cut-off that may remove any common words. These extracted words are then fed back to the user as suggestive tokens that describe that relation. The user may add or remove new tokens to that list and save the relation. The search pattern, default values and number of words extracted are implementation dependent and can vary between implementations.

The final features extracted for a new relation may be compared with other relations on store to check if there are overlaps and if so, suggest the alternate stored or existing relation name back to user.

When operating in an automatic extraction mode, the PME 215 can automatically establish a relation between a subject data item and an object data item. This enables automated linkage of different types of data within the information resource 111 that makes a particular data item or set much richer due to the extensive set of relations connecting the item to other object data items.

In one embodiment, the PME 215 engages the automatic extraction mode based on certain criteria. For example, the PME 215 determines that both the subject data item and the potential object data item are associated with data types for which additional descriptive features are available. In some embodiments, the PME 215 determines whether features are available by searching the TRD 205 for the respective data types. In some cases, the PME 215 may also check for presence of appropriate language models and/or topic vocabularies to be able to determine semantic relationships between the data items and/or the relations. The relations are then generated based on the semantic relationships.

More specifically, the automatic extractions of new relations are formed through monitoring of the information resource 111 for potential changes to the data. In one embodiment, the monitoring parameters may be set by an administrator, information owner, user, service provider, and the like. These parameters include, for instance, monitoring frequency, spatial setting for overlap topics in the language model, specific data types for which relations may be computed, minimum or predetermined number of relations to trigger automatic predicate generation (e.g., predicate generation is triggered if the data items already has at least a predetermined number relations).

By way of example, relation computation and generation can be based on contextual or semantic overlap within a boundary set within the system 100 (e.g., the data items such as the subject and object should be associated with features or language tokens that overlap). The contextual overlap may be context related. For example, for a mapping service, the context may include spatial boundaries (e.g., restaurants within a particular area), a combination of spatial and temporal boundaries (e.g., restaurants within a particular area that are open at a particular time), and the like. Accordingly, if the context overlap occurs (e.g., a new restaurant is added in a particular area), automatic predicate generation can be initiated. It is contemplated that any relevant context or no context at all may be used to initiate predicate generation process.

To perform these functions and as shown in FIG. 3, the PME 215 includes a context monitor 301 that monitors the information resource 111 according to the monitor settings 303 and feeds data of discovered subject and object data items to a feature aggregator 305. The feature aggregator 305 combines the features of the data sets and provides the features to a LLDA (Label Latent Dirichlet Process) based distribution build 309 or any other probability-based matching algorithm. The feature aggregator 305 also extracts more language tokens from the language model 307 related to each feature so that a much richer set of tokens (words) are available in the relation vocabulary 311 for relation modeling 313. This LLDA based process builds a distribution pattern 315 of latent topics within the feature list. This distribution is passed to a pattern matcher 317 that matches the received pattern with a set of available pre-computed patterns of relations. The relation pattern that forms the best match is taken and fed to the predicate decision engine 213. In one embodiment, the relation patterns are pre-computed and built by the RME 201. The PDE 213 may further use the relation to link the two data sets or feed the same to the modeling manager 103 and/or the resource view application 117 for a final decision or approval by the system operator or user.

FIG. 4 illustrates a graphical representation of a language modeling lattice comprising a plurality of language tokens, according to one embodiment. In one embodiment, for each information resource, data item, relation, feature, or other like information, the modeling manager 103 extracts one or more language tokens (e.g., each language token represents a word or phrase). For instance, each of the information resources 111 is crawled and parsed to obtain text. Since the text data are largely unstructured and can comprise tens of thousands of words, automated topic modeling can be used for locating and extracting language tokens from the text. In one embodiment, the modeling manager 103 extracts the noun tokens, and then performs a histogram cut to extract only the least common nouns. To extract the noun tokens, the modeling manager 103 can deploy a part-of-speech tagging (POTS) to mark up nouns in the text. POTS is a process of marking up nouns in a text (corpus) as corresponding to a particular part of speech, based on both its definition, as well as its context. Part-of-speech tagging is more than just having a list of words and their parts of speech, because some words can represent more than one part of speech at different times. For example, “dogs” is usually a plural noun, but can be a verb. The modeling manager 103 then extracts nouns using a language dictionary, and stores the noun tokens as a noun set.

The noun set obtained is then used to build a model to represent the information resource, data items, relations, features, etc. by extracting tokens with similar probability and range from a larger language model (e.g., Wikipedia or other large collection of meaningful words) or performing other similar probabilistic analysis of the tokens. In one example, topic models, such as Latent Dirichlet Allocation (LDA), are useful tools for the statistical analysis of document collections. For example, LDA is generative probabilistic model as well as a “bag of words” model. In other words, the extracted words or tokens are assumed to be exchangeable within them. The LDA model assumes that the words of each document or data item arise from a mixture of topics, each of which is a probability distribution over the vocabulary. As a consequence, LDA represents documents as vectors of word counts in a very high dimensional space, while ignoring the order in which the words or tokens appear. While it is important to retain the exact sequence of words for reading comprehension, the linguistically simplistic exchangeability assumption is essential to efficient algorithms for automatically eliciting the broad semantic themes in a collection of language token.

Another example of a modeling algorithm is the probabilistic latent semantic analysis (PLSA) model. PLSA is a statistical technique for analyzing two-mode and co-occurrence data. PLSA was evolved from latent semantic analysis, and added a sounder probabilistic model. PLSA has applications in information retrieval and filtering, natural language processing, machine learning from text, and related areas.

As shown in FIG. 4, the topology or lattice of the language model generated by the modeling manager 103 is implemented as a data file, organized in accordance with a precise data structure (e.g., a lattice structure) so as to be readily interpreted, analyzed, reconstructed or deconstructed. Within this data file are one or more representative topics associated with relations/predicates and their associated features. In the context of the present examples, a “token” is a single data point or variable within a representative set 400 of common data points. As such, the set of tokens comprising the topology define a fixed, but expandable, set of potential relations and/or features among data items. For the sake of clarity, the term “token” and “topic” will be recognized as synonymous terms, as the computational or semantic processing of the topology data file ultimately results in abstraction of the topics into one or more tokens.

Generally, a token can be a keyword, an operator, punctuation mark or any combination of words and/or characters comprising an input string or input document. In the context of the present example, each top level topic 401, 403 through 423 represent a pre-defined number of noun tokens—e.g., 15 top level tokens derived by the system 100 (e.g., during automatic predicate generation) or provided as input by the user (e.g., during user provided or directed predicate generation). Hence, each descriptor variable of a given token is semantically recognized as a noun, i.e., “Art,” “Business,” etc. Each topic is further divided into one or more subclasses for further organization into subtopics. The predetermined topology 400 is thus hierarchically arranged, such that a defined/controlled number of top-level topical tokens 401, 403 and 423 (e.g., topics) have respective subcategories 407, 411, 413, 417 and 421 (e.g., subtopics). Subclasses of a given topic 401, 403 and 423 within the hierarchy can go down multiple depths and levels (further subclasses), representing, for instance, anywhere between 30-50 tokens depending on the nature of the top-level category.

With this in mind, it is not uncommon for the predetermined topology 400 of topics and subtopics of relations and features to represent a super-set of at least 750 tags or topics. Typically, the relations and/or features would belong to one or more (say 5) of the top classes (e.g., topics, categories) and then several of the sub-classes under each class that the user has chosen. Furthermore, the hypothetically presented number of 750 tokens is by way of example, not limitation. It is further contemplated that the number of tokens will grow as the granularity of topics rise and as new genres get identified or refined over time. Accordingly, the relations and features incorporated into the language can increase correspondingly.

With reference again to FIG. 4, each token within the topographical set 400 is also associated with a corresponding set of reference tokens. The set of reference tokens represents one or more tokens abstracted from a reference document assigned to each topic and subtopic of the predetermined topology. The reference document is a resource that is determined to closely match the subject matter represented by the corresponding topic. As such, a reference document provides a means of enabling contextual correlation between the topical token and its actual semantic use. So, for example, Token 407 for the noun “ABSTRACT,” has two associated documents 409, each of which would pertain to the subject matter of abstract art. Token 417 for noun “PAYROLL,” has 3 associated documents 419, each of which would pertain to the subject matter of payroll in the context of business. By way of example, the documents 419 may be specified from one or more online document repositories (e.g., Wikipedia or any other source) providing topic-related documents. In one embodiment, the modeling manager 103 can extract a set of reference tokens from each reference document to represent the topic and serve as a basis for probability matching of tokens extracted from user documents 201b. In one embodiment, the probability matching is based on a topic aware LLDA based distribution build 409.

In combination, the representative tokens abstracted from each individual reference document act as a language model (LM) 209, providing language specific information that can be used for deriving contextually accurate and relevant tokens representative of the relations and/or features processed by the modeling manager 103. It will be generally recognized by skilled artisans that while the illustration depicts various documents in association with a given token, indeed, this implicates a mapping of complimentary reference tokens as well.

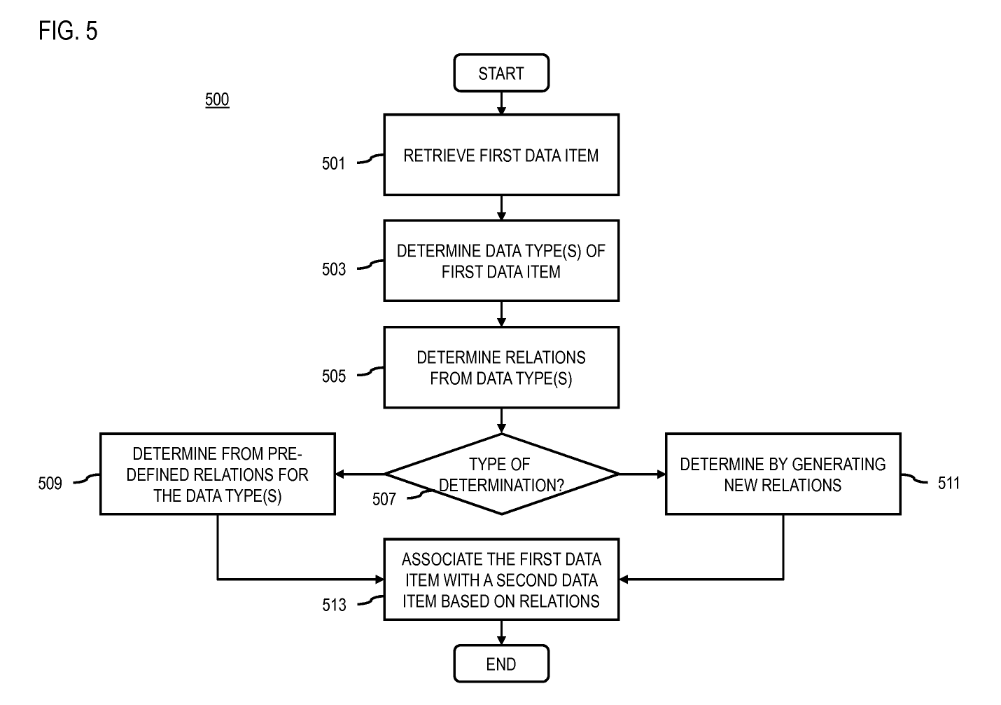

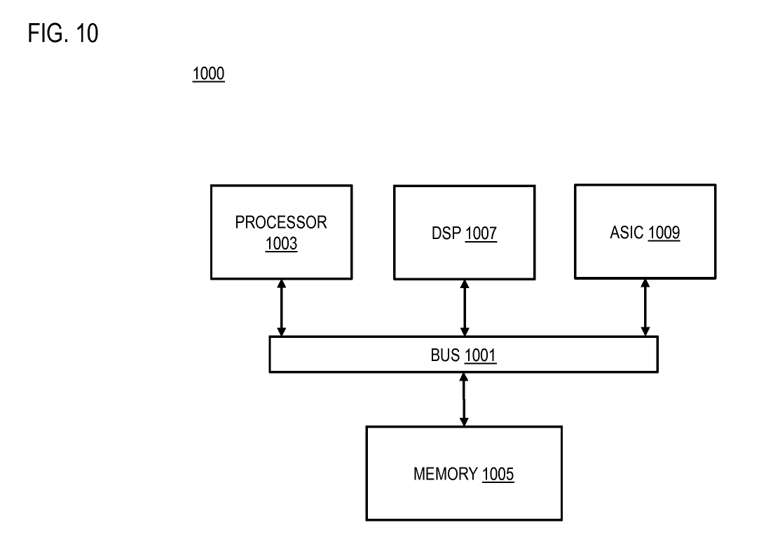

FIG. 5 is a flowchart of a process for modeling relations among data items of one or more information resources, according to one embodiment. In one embodiment, the modeling manager 103 performs the process 500 and is implemented in, for instance, a chip set including a processor and a memory as shown FIG. 10. In addition or alternatively, the RME 201 may perform all or a portion of the process 500. At step 501, the modeling manager 103 retrieves a first data item from an information resource 111a. The data item may be, for instance, a data structure including multiple fields, a single field of a data record, a key-value pair, or the like. In this example, the first data item can be a subject of a RDF-encoded data set (e.g., a subject of a triple).

Next, the modeling manager 103 determines the data type of the first data item (step 503). It is noted that data type often is highly specific to the category of the data represented in the data item. For example, in a mapping service, the data type may be described in relation to a type of POI. The data type may be, for instance, a category of the POI such as a tourist attraction or a restaurant. If the information resource is a media database, the data type may describe a musical track or an image file.

Based on the data type, the modeling manager 103 next determines relations or predicates that might be associated with the data type (step 505). In certain embodiments, the modeling manager 103 may also determine features related to the data type to facilitate predicate generation. For example, if the data type of the data item is a tourist attraction, possible predicates may include name, location, historical significance, hours of operation, popularity, etc.; whereas if the data type is a musical track, possible predicates may include publisher, genre, artist, etc.

In one embodiment (at step 507), the modeling manager 103 may determine the relations for particular data types based on a predetermined set of relations (step 509) or by generating new relations based on semantic modeling or user input (step 511). If determining the relations using a predetermined set of relations, the modeling manager 103 may retrieve or search a list of relations for a given data type from, for instance, the TRD 205. As described previously, the TRD 205 is a database containing specified and/or previously determined relations based on data types, the data items, the type of relations, etc. In this case, modeling manager 103 the relations will be specified for each available data type.

If there is not previously specified relations for the data type or if directed, the modeling manager 103 can generate new relations based on, for instance, a semantic analysis (e.g., via language models) of the first data to extract language tokens for defining semantically based relations for the data item. For example, if the data item is a car, the modeling manager 103 can process the data item name (e.g., “car”), candidate relations (e.g., predicates), and/or candidate objects through one or more language models to generate semantically appropriate relations (e.g., color, make, and model may be semantically close descriptors of car).

After defining the relations, the modeling manager 103 may then associate the first data time with a second data item based on the relations (step 513). More specifically, the modeling manager 103 can semantically process one or more information resources 111 to determine semantic relationships among the data items and/or the relations. The association may be represented in RDF format as a triple wherein the first data item is the subject, the relation is the predicate, and the second data item is the object of the triple.

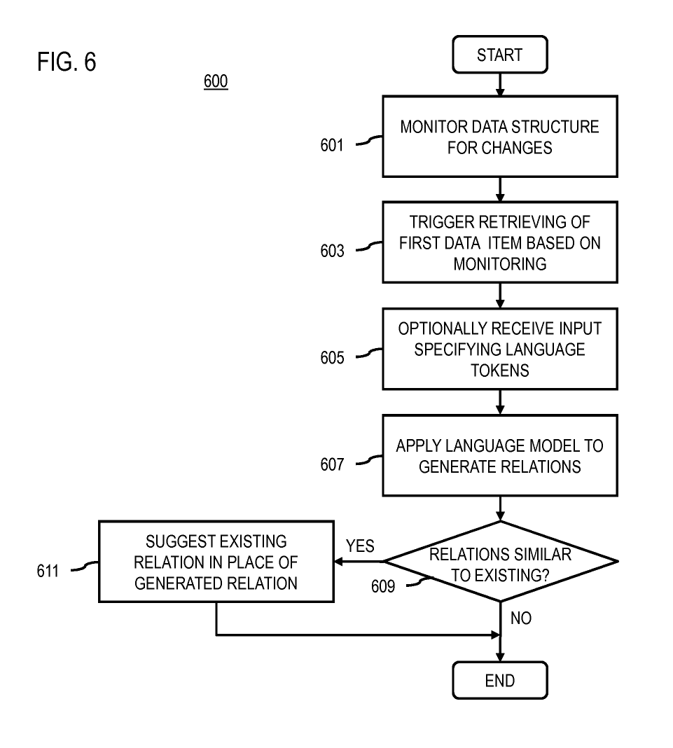

FIG. 6 is a flowchart of a process for monitoring an information resource to automatically generate relations among data items, according to one embodiment. In one embodiment, the modeling manager 103 performs the process 600 and is implemented in, for instance, a chip set including a processor and a memory as shown FIG. 10. In addition or alternatively, the RME 201 may perform all or a portion of the process 600. At step 601, the modeling manager 103 monitors a data structure (e.g., an information resource 111) for changes. On detection of a change to the data structure, the modeling manager 103 triggers the retrieving of the first data item or record as described in the process 500 of FIG. 5 to initiate the predicate generation process (step 603).

As described previously, the predicate generation process can be optionally based on receiving input (e.g., from a user) specifying language tokens associated with one or more relations or features of the relations (step 605). In addition or alternatively, the modeling manager 103 can extract additional language tokens based on the user specified tokens or other information associated with the first data item, potential relations, and/or potential objects.

These language tokens (e.g., user specified tokens, automatically generated tokens, or a combination thereof) are then used by the modeling manager 103 to generate relations (step 607). The relations are generated by applying one or more language models to the corresponding language tokens. The output of the language models is, for instance, relations that are semantically related to the language tokens representing the first data item, potential relations, and/or potential objects.

The modeling manager 103 then determines whether the generated relations are similar (e.g., semantically similar) to existing or previously defined relations (step 609). If the generated relations are similar, the modeling manager 103 may suggest combining or substituting one or more of the existing relations and related data for one or more of the generated relations.

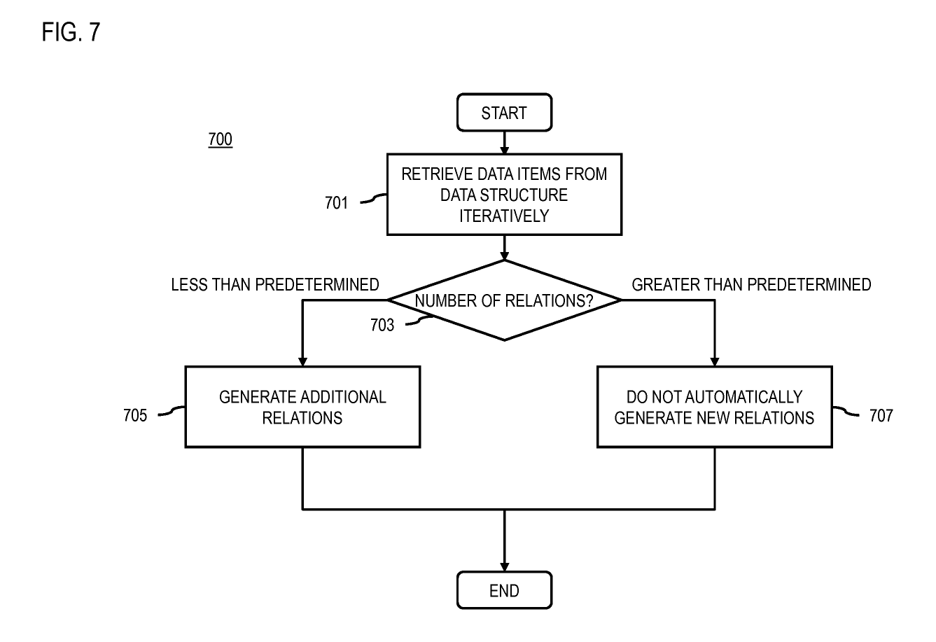

FIG. 7 is a flowchart of a process for iteratively processing an information resource to generate relations among data items, according to one embodiment. In one embodiment, the modeling manager 103 performs the process 700 and is implemented in, for instance, a chip set including a processor and a memory as shown FIG. 10. In addition or alternatively, the RME 201 may perform all or a portion of the process 700. As part of the automatic predicate generation process, the modeling manager 103 may iteratively retrieve data items for a data structure or information resource 111 of interest for predicate generation (step 701). In this way, the modeling manager 103 can process an entire information resource 111 record by record to generate new or fill in missing relations for each record.

During this iterative process, the modeling manager 103 may apply logic or criteria to determine whether to generate relations. For example, the modeling manager 103 may operate based on whether a particular data item or record is associated with at least a minimum or a predetermined number of relations (step 703). If the data item is associated with less than the predetermined number of relations or predicates, the modeling manager initiates the predicate generation process to add additional or missing relations to the data item (step 705). If the data is associate with greater than the minimum or predetermined number of relations, the modeling manager 103 may skip the predicate generation process or may ask the user to confirm whether additional relations should be generated for the data item (step 707). In this way, the modeling manager can attempt to equalize the number of available relations for each data item. In addition, the modeling manager 103 may reduce the computational burdens by generating relations only for those data items or records for which there are insufficient numbers of relations.

Although the example FIG. 7 is based on a minimum number of records, it is contemplated that the modeling manager 103 may apply any logic, criteria, or context (e.g., available storage, popularity of the data item, etc.) to determine whether to generate relations for a particular data item.

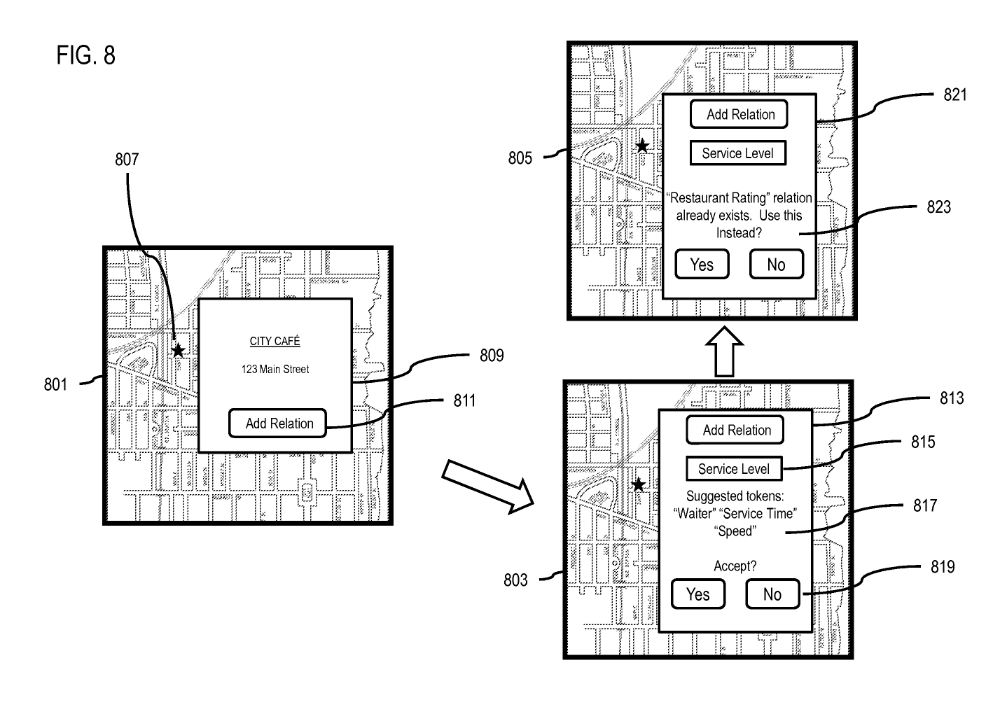

FIG. 8 is a diagram of user interfaces used in the processes of FIGS. 5-7, according to various embodiments. The user interfaces 801-805 illustrate an example of predicate generation process described herein as applied in a mapping service. The user interface 801 depicts a map displaying a POI data item 807 and a corresponding information box 809. As shown, the information box 809 presents the currently specified relations for the POI 807. For example, the box 809 displays a name relation (e.g., City Café) and a location relation (e.g., 123 Main St.). The box 809 also presents an option 811 to add a new relation to the POI 807.

On selecting the option 811 to add a relation, the user interface 803 is presented. The information box 813 then displays a text entry field 815. In this example, the user has typed “Service Level” in the text entry field 815. In response, the modeling manager 103 applies a language model on the entered text to generate suggested tokens 817 that describe the features related to the text. The user may then use the controls 819 to accept or reject the suggested tokens.

On acceptance of the tokens, the modeling manager 103 compares the requested relation to existing relations to determine whether any are similar. In one embodiment, similarity is evaluated based on a semantic similarity of the requested and existing relations (e.g., based on probability matching of language tokens associated with each of the relations). The modeling manager presents the results of the comparison in the information box 821 which indicates that there “Restaurant Rating” is similar to “Service Level.” Accordingly, the modeling manager 103 displays a message asking whether the user would like to use the existing relation instead.

If the user indicates no, the modeling manager 103 generates a new relation and attempts to populate the relation by applying a language model to determine appropriate objects or data items to connect to the POI via the newly generated relation. Once populated, the user can select the POI and view the newly added relation (not shown).

The processes described herein for modeling relations among data items may be advantageously implemented via software, hardware, firmware or a combination of software and/or firmware and/or hardware. For example, the processes described herein, including for providing user interface navigation information associated with the availability of services, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

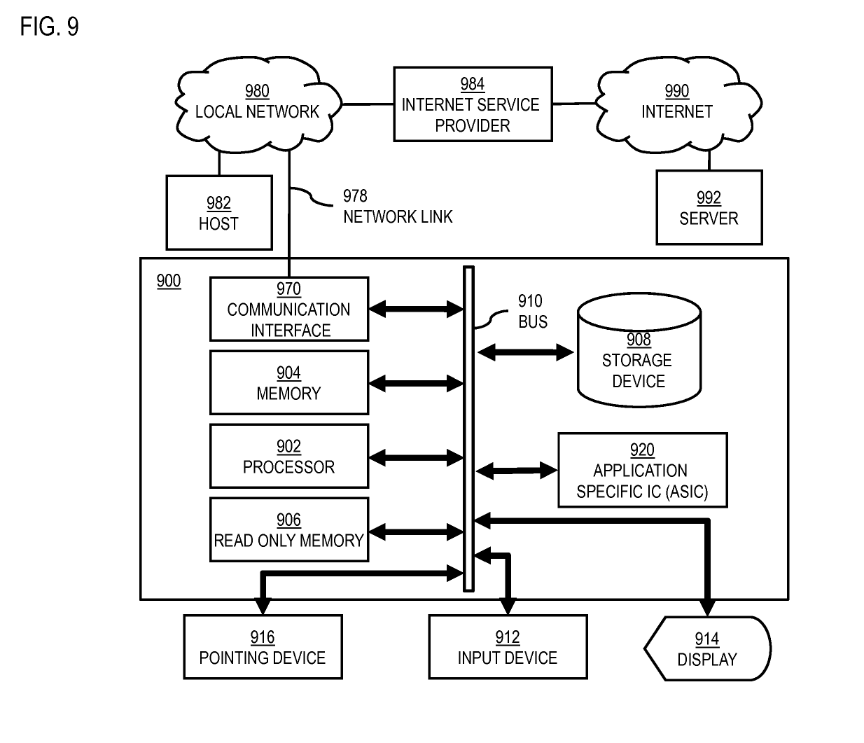

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 9 can deploy the illustrated hardware and components of system 900. Computer system 900 is programmed (e.g., via computer program code or instructions) to model relations among data items as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of modeling relations among data items.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to modeling relations among data items. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or other dynamic storage device, stores information including processor instructions for modeling relations among data items. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for modeling relations among data items, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT) or a liquid crystal display (LCD), or plasma screen or printer for presenting text or images, and a pointing device 916, such as a mouse or a trackball or cursor direction keys, or motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914 and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of application specific ICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic or electromagnetic signals, including infrared and optical signals, that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 105 for modeling relations among data items.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980 and communications interface 970. The received code may be executed by processor 902 as it is received, or may be stored in memory 904 or in storage device 908 or other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

FIG. 10 illustrates a chip set or chip 1000 upon which an embodiment of the invention may be implemented. Chip set 1000 is programmed to model relations among data items as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of services. Chip set or chip 1000, or a portion thereof, constitutes a means for performing one or more steps of modeling relations among data items.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to model relations among data items. The memory 1005 also stores the data associated with or generated by the execution of the inventive steps.

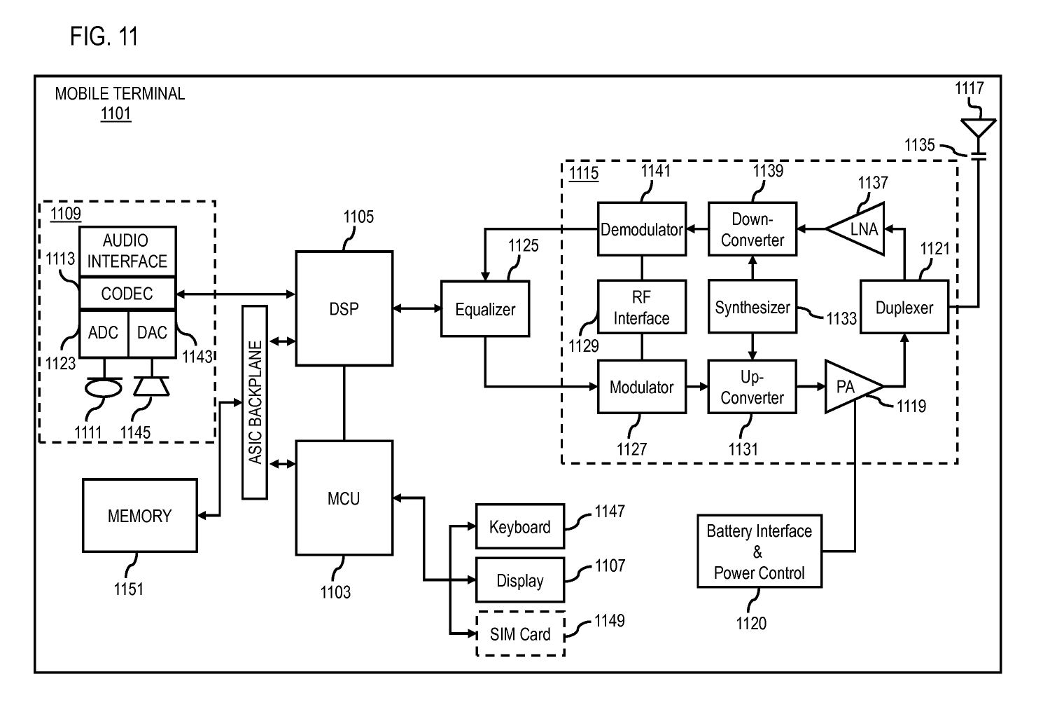

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of modeling relations among data items. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of modeling relations among data items. The display 1107 includes display circuitry configured to display at least a portion of a user interface of the mobile terminal (e.g., mobile telephone). Additionally, the display 1107 and display circuitry are configured to facilitate user control of at least some functions of the mobile terminal. An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103—which can be implemented as a Central Processing Unit (CPU) (not shown).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 to model relations among data items. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
retrieving, at a device, a first data item;
determining one or more data types associated with the first data item;
determining one or more relations corresponding to the first data item based, at least in part, on the one or more data types; and
associating the first data item with a second data item based, at least in part, on a semantic relationship among the first data item, the second data item, the one or more relations, or a combination thereof.

2. A method of claim 1, wherein the first data item, the one or more relations, and the second data item are represented as a triple, and wherein the first data item is a subject of the triple, the one or more relations are predicates of the triple, and the second data item is an object of the triple.

3. A method of claim 1, wherein the one or more relations are pre-defined respectively for the one or more data types.

4. A method of claim 1, wherein the determining of the one or more relations comprises:
causing, at least in part, application of a language model on the first data item, the second data item, or a combination thereof to generate the one or more relations.

5. A method of claim 4, further comprising:
receiving an input for specifying one or more language tokens,
wherein the application of the language model is based, at least in part, on the one or more language tokens.

6. A method of claim 5, wherein the one or more language tokens describe the first data item, the second data item, the one or more relations, one or more related features, or a combination thereof.

7. A method of claim 5, wherein the input is provided by one or more sensors of the device, another device associated with a user, a service, or a combination thereof.

8. A method of claim 1, wherein the first data item is associated with a data structure, the method further comprising:
causing, at least in part, monitoring of the data structure for changes; and
triggering the retrieving of the first data item based, at least in part, on the monitoring.

9. A method of claim 1, further comprising:
determining whether the first data is associated with a predetermined number of relations,
wherein the determining of the one or more relations is based, at least in part, on the predetermined number of relations.

10. A method of claim 1, further comprising:
determining whether the one or more relations are similar or substantially similar to one or more pre-existing relations; and
suggesting the one or more pre-existing relations to replace the one or more relations based, at least in part, on the similarity determination.

11. An apparatus comprising:
at least one processor; and
at least one memory including computer program code for one or more programs,
the at least one memory and the computer program code configured to, with the at least one processor, cause the apparatus to perform at least the following,
retrieve, at a device, a first data item;
determine one or more data types associated with the first data item;
determine one or more relations corresponding to the first data item based, at least in part, on the one or more data types; and
associate the first data item with a second data item based, at least in part, on a semantic relationship among the first data item, the second data item, the one or more relations, or a combination thereof.

12. An apparatus of claim 11, wherein the first data item, the one or more relations, and the second data item are represented as a triple, and wherein the first data item is a subject of the triple, the one or more relations are predicates of the triple, and the second data item is an object of the triple.

13. An apparatus of claim 11, wherein the one or more relations are pre-defined respectively for the one or more data types.

14. An apparatus of claim 11, wherein the determining of the one or more relations comprises:
causing, at least in part, application of a language model on the first data item, the second data item, or a combination thereof to generate the one or more relations.

15. An apparatus of claim 14, wherein the apparatus is further caused to:
receive an input for specifying one or more language tokens,
wherein the application of the language model is based, at least in part, on the one or more language tokens.

16. An apparatus of claim 15, wherein the one or more language tokens describe the first data item, the second data item, the one or more relations, one or more related features, or a combination thereof.

17. An apparatus of claim 15, wherein the input is provided by one or more sensors of the device, another device associated with a user, a service, or a combination thereof.

18. An apparatus of claim 11, wherein the first data item is associated with a data structure, and wherein the apparatus is further caused to:
cause, at least in part, monitoring of the data structure for changes; and
trigger the retrieving of the first data item based, at least in part, on the monitoring.

19. An apparatus of claim 11, wherein the apparatus is further caused to:
determine whether the first data is associated with a predetermined number of relations,
wherein the determining of the one or more relations is based, at least in part, on the predetermined number of relations.

20. An apparatus of claim 11, wherein the apparatus is further caused to:
determine whether the one or more relations are similar or substantially similar to one or more pre-existing relations; and
suggest the one or more pre-existing relations to replace the one or more relations based, at least in part, on the similarity determination.

21.-61. (canceled)
